(19) United States
(12) Patent Application Publication
(10) Pub. No.: US 2025/0206382 A1
(43) Pub. Date: Jun. 26, 2025

(54) REAR STRUCTURE OF VEHICLE BODY

(71) Applicants: Hyundai Motor Company, Seoul (KR); Kia Corporation, Seoul (KR)

(72) Inventors: Jiae Yong, Hwaseong-si (KR); SungWoong Ha, Hwaseong-si (KR)

(21) Appl. No.: 18/961,879

(22) Filed: Nov. 27, 2024

(30) Foreign Application Priority Data
Dec. 20, 2023 (KR) 10-2023-0186851

(51) Int. Cl. B62D 25/08

(52) U.S. Cl. CPC B62D 25/08

(57) ABSTRACT

An embodiment rear structure of a vehicle body includes a rear panel positioned at a rear of the vehicle body and a lower member having an “L” shape cross-section, wherein the lower member includes an upper junction part on an upper portion of the cross-section, and wherein the upper junction part is joined at a rear of the rear panel.

### CROSS-REFERENCE TO RELATED APPLICATIONS

This application claims the benefit of Korean Patent Application No. 10-2023-0186851, filed on Dec. 20, 2023, which application is hereby incorporated herein by reference.

### TECHNICAL FIELD

The present invention relates to a rear structure of a vehicle body.

### BACKGROUND

Recently, the vehicle industry is introducing a new concept of future mobility vision for realizing a human-centered, dynamic future city. One of these future mobility solutions is the purpose built vehicle (PBV) as a purpose-based mobility.

An example of a PBV is an electric vehicle (EV)-based environmentally friendly mobility vehicle. These PBVs can provide users with various customized services while traveling from a starting point to a destination in an unmanned or manned autonomous driving mode.

The PBV can be configured in various forms depending on the type of customized service. For example, the PBV can be used as a hailing type vehicle that configures a cabin to transport occupants. Furthermore, the PBV can be utilized as a cab type vehicle with a cabin configured only in the front part of the upper body or as a delivery type vehicle with a cabin configured in the front part of the upper body and a luggage room configured in the rear part.

However, the vehicle type that is produced by loading the back panel in the vertical direction is not easily applicable to a delivery vehicle that must load cargo in the vertical direction on the rear floor flange.

In addition, the van-type vehicle is produced by loading the floor panel last into the upper body member structure, making it difficult to share the floor with other vehicles.

That is, when lowering the floor to improve loading performance, the van-type vehicle has insufficient space to form a back cross-section due to its flat cross-section configuration.

For the PBV, a vehicle body structure that can be produced in combination with various body types according to specifications while maintaining consistent performance is required.

That is, it is required to support various body type specifications of the PBV such as the hailing vehicle type and the delivery vehicle type, and a vehicle body combination structure that enables combination production by specification through common use of parts is required.

The information contained in this background section has been prepared to promote understanding of the background of embodiments of the invention and may include matters that are not already known prior art.

### SUMMARY

The present invention relates to a rear structure of a vehicle body. More particularly, the present disclosure relates to a rear structure of a vehicle body that can be applied to various vehicle types by ensuring production flexibility.

A rear structure of a vehicle body according to an embodiment may include a rear panel positioned at the rear of the vehicle body and a lower member formed by a cross-section having an “L” shape, including an upper junction part formed on the upper portion of the cross-section, and to which the upper junction part is joined at the rear of the rear panel.

The upper junction part may be formed in a horizontal direction parallel to the rear panel.

The lower member may further include a lower junction part formed at the lower part of the cross-section.

The lower junction part may be formed in the vertical direction of the vehicle body.

The rear structure according to an embodiment may further include a back panel connected to the upper junction part and the lower junction part and forming a back panel closed section therebetween with the lower member.

The back panel may be connected to the lower member in the vertical direction of the vehicle body.

The back panel may include an upper back panel connected to the upper junction part in a shape parallel to the rear panel and a lower back panel connected to the lower junction part.

The back panel may further include a front connection portion formed in a horizontal direction parallel to the rear panel and formed on the front of the upper back panel where the upper back panel and the rear panel are connected.

The back panel may include a front body connected to the upper junction part, a rear body connected to the lower junction part, and a main body formed by protruding upward from the front body and the rear body.

The back panel may further include a front connection portion formed in a horizontal direction parallel to the rear panel and formed on the front of the front body where the front body and the rear panel are connected.

The back panel may further include a main body closed section formed within the main body.

The rear panel may include a rear panel side portion formed by bending upward in the width direction of the vehicle body, and the lower member may include a lower member side portion which is formed by bending upward in the width direction of the vehicle body and is connected to the rear of the rear panel side portion.

The vehicle body may include a chassis frame, and the lower member side portion may be connected to the chassis frame.

The vehicle body may include a side member, and the lower member side portion may be connected to the side member.

According to an embodiment of the rear structure of a vehicle body, it can be applied to various vehicle types by securing production flexibility.

According to an embodiment of the rear structure of a vehicle body, the production cost can be reduced by increasing the common number of parts applicable to various vehicle types.

According to the rear structure of a vehicle body according to an embodiment, production efficiency can be improved by integrating production methods of various vehicle types.

In addition, the effects that can be obtained or expected from embodiments of the present invention are directly or implicitly disclosed in the detailed description of the embodiments of the present invention. That is, various effects predicted according to embodiments of the present invention will be disclosed in the detailed description to be provided later.

### BRIEF DESCRIPTION OF THE DRAWINGS

Since these drawings are for reference in explaining exemplary embodiments of the present invention, the technical ideas of the embodiments of the present invention should not be interpreted as limited to the attached drawings.

FIG. 1 is a perspective view showing a rear structure of a vehicle body according to an embodiment.

FIG. 2 is a partially exploded perspective view showing the rear structure of a vehicle body according to an embodiment.

FIG. 3 is a partial cross-sectional view along line III-III of FIG. 1.

FIG. 4 shows an example of the rear structure of a vehicle body applied to a delivery vehicle according to an embodiment.

FIG. 5 shows an example of the rear structure of a vehicle body applied to a hailing vehicle according to an embodiment.

FIG. 6 and FIG. 7 are drawings showing an example in which the rear structure of a vehicle body according to an embodiment is applied to a chassis frame vehicle body.

FIG. 8 is a drawing showing an example of the rear structure of a vehicle body applied to a monocoque vehicle body according to an embodiment.

FIG. 9 and FIG. 10 are drawings showing examples of a connection between the rear structure of a vehicle body and the monocoque vehicle body according to an embodiment.

The following reference identifiers may be used in connection with the drawings to describe various features of embodiments of the present invention.

10: vehicle body
12: chassis frame
14: mounting bolt
16: side member
20: rear panel
22: rear panel side portion
30: lower member
32: upper junction part
34: lower junction part
36: lower member first body
38: lower member second body
40: lower member side portion
50, 51: back panel
54: back panel closed section
60: upper back panel
62: lower back panel
64: front connection portion
70: main body
71: main body connecting member
72: front body
74: rear body
76: front connection portion
78: main body closed section
79: back panel closed section
80: back complement
W1, W2: welding portion

It should be understood that the drawings referenced above are not necessarily drawn to scale, but rather present rather simplified representations of various preferred features illustrating the basic principles of embodiments of the present invention.

For example, specific design features of embodiments of the present invention, including particular dimensions, orientations, locations, and shapes, will be determined in part by the particular intended application and usage environment.

### DETAILED DESCRIPTION OF ILLUSTRATIVE EMBODIMENTS

Hereinafter, with reference to the attached drawings, embodiments of the present invention will be described in detail so that a person having ordinary skill in the art to which the present invention pertains can easily practice the present invention.

As those skilled in the art would realize, the described embodiments may be modified in various different ways, all without departing from the spirit or scope of the present invention.

In order to clearly explain embodiments of the present invention, parts irrelevant to the description are omitted, and the same reference numerals are used for identical or similar components throughout the specification.

The size and thickness of each component shown in the drawings are arbitrarily shown for convenience of explanation, and the embodiments of the present invention are not necessarily limited to what is shown in the drawings. In order to clearly express various parts and areas, the thickness is shown by enlarging it.

In addition, in the detailed description below, the names of the components are divided into first, second, etc. to distinguish them when the components are in a similar relationship, and the description below is not necessarily limited to that order.

Throughout the specification, whenever a part is said to include a certain component, this does not mean that it excludes other components, but rather that it may include other components, unless otherwise specifically stated.

Additionally, terms such as part, portion, means, etc. described in the specification mean comprehensive units of composition that perform at least one function or operation.

When we say that a part, such as a layer, membrane, region, or plate, is “over” another part, this includes not only cases where it is directly over the other part, but also cases where there are other parts in between.

In contrast, when an element is referred to as being “directly on” another element, there are no intervening elements present.

In this specification, the term ‘connected’ indicates that a physical relationship exists between two components, for example, in which components are directly connected to each other by welding, self piercing rivet (SPR), flow drill screw (FDS), structural adhesive, or the like, or in which components are indirectly connected through one or more intermediate components.

As used herein, ‘vehicle’, ‘vehicular’, ‘automotive’ or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs, hydrogen-powered vehicles and other alternative fuel vehicles (e.g., other than petroleum fuel derived from resources).

In this specification, the reference direction for explaining the components below may be set as the front-rear direction of the vehicle body (e.g., body length direction or longitudinal direction), the width direction (e.g., lateral direction or left-right direction), and the up-down direction (e.g., height direction or vertical direction) based on the vehicle body.

In this specification, ‘upper end’, ‘upper portion’, or ‘upper surface’ of a component indicates an end, portion, or surface of a component that is relatively upper in the drawing, and ‘lower end’, ‘lower portion’, or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

Embodiments will hereinafter be described in detail with reference to the accompanying drawings.

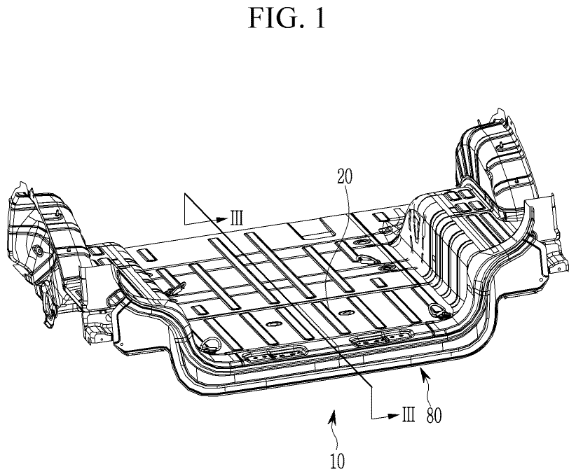

FIG. 1 is a perspective view showing a rear structure of a vehicle body according to an embodiment.

Referring to FIG. 1, a rear structure of a vehicle body according to an embodiment includes a rear panel 20 disposed at the rear of a vehicle body 10, and a back complement 80 (also called a rear complement in the art) is mounted at the rear of the rear panel 20.

The back complement 80 is a combination of a lower member and a back panel described below.

The vehicle body 10 to which the rear structure of a vehicle body according to an embodiment may be applied may be a PBV, and it may be applied to various types of vehicles, such as a hailing type vehicle that configures a cabin to transport occupants, a cab type vehicle that configures a cabin only in the front part of the upper body, and a delivery type vehicle that configures a cabin in the front part of the upper body and a luggage room in the rear part.

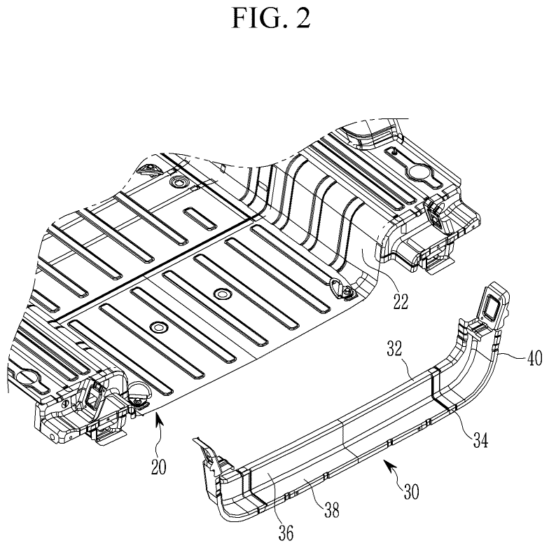

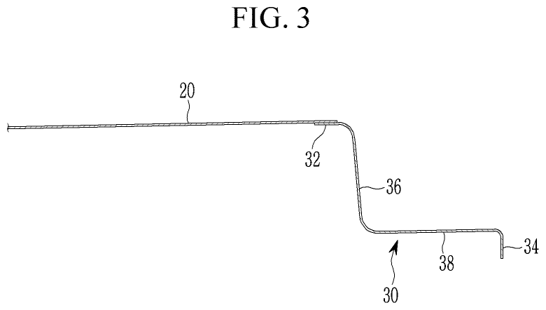

FIG. 2 is a partially exploded perspective view showing the rear structure of a vehicle body according to an embodiment, and FIG. 3 is a partial cross-sectional view along line III-III of FIG. 1.

Referring to FIG. 1 to FIG. 3, the rear structure of a vehicle body according to an embodiment may include a lower member 30 connected to the rear panel 20.

The lower member 30 includes an upper junction part 32, and the upper junction part 32 is connected to the rear of the rear panel 20.

The lower member 30 includes a lower member first body 36 and a lower member second body 38 formed by a bend from the lower member first body 36, and the lower member first body 36 and the lower member second body 38 may form an “L” shaped cross-section.

The upper junction part 32 may be formed by bending from the lower member first body 36.

That is, the upper junction part 32 may be formed in a horizontal direction parallel to the rear panel 20.

The lower member 30 may further include a lower junction part 34 formed at the lower portion of the cross-section.

The lower member 30 may be formed in the vertical direction of the vehicle body 10.

That is, the lower junction part 34 may be bent in the lower direction of the vehicle body 10 at the lower member second body 38.

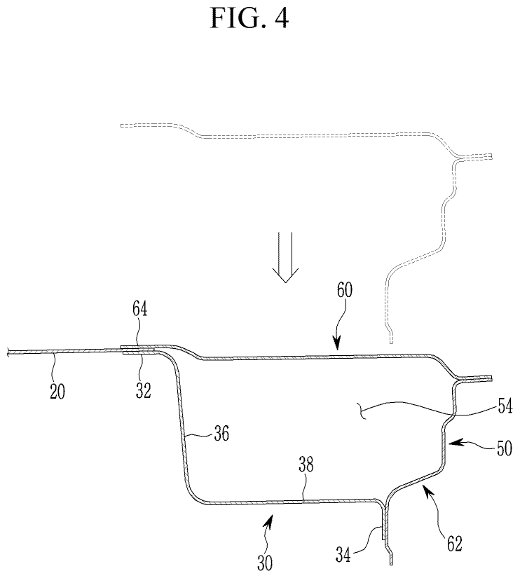

FIG. 4 shows an example of the rear structure of a vehicle body applied to a delivery vehicle according to an embodiment.

Referring to FIG. 1 to FIG. 4, the rear structure of a vehicle body according to an embodiment may further include a back panel 50 connected to the upper junction part 32 and the lower junction part 34, forming a back panel closed section 54 therebetween with the lower member 30.

The lower member 30 and the back panel 50 form the back panel closed section 54, which increases the width direction cross-section coefficient of the vehicle body 10 and can enhance the width direction strength of the vehicle body 10.

Additionally, the back panel closed section 54 may act as a buffer to absorb impact in the event of a rear collision of the vehicle.

The back panel 50 may include an upper back panel 60 connected to the upper junction part 32 in a shape parallel to the rear panel 20 and a lower back panel 62 connected to the lower junction part 34.

Here, it is shown that two panels, the upper back panel 60 and the lower back panel 62, are combined to form the structure, but it is not limited thereto, and it may be a configuration in which one or three or more panels are combined.

The back panel 50 may further include a front connection portion 64, which is formed in a horizontal direction parallel to the rear panel 20 and which is formed on a front of the upper back panel 60 where the upper back panel 60 and the rear panel 20 are connected.

Therefore, as shown in the drawing, the back panel 50 may be connected to the lower member 30 in the vertical direction of the vehicle body 10.

For a delivery vehicle capable of loading from the rear direction, it is required that there be no structure at the rear of the vehicle that impedes loading or unloading of goods.

In the rear structure of a vehicle body according to an embodiment, the lower member 30 has an “L” shaped cross-section, and the lower member 30 may be connected in the vertical direction of the vehicle body 10 without a configuration that interferes with getting on and off.

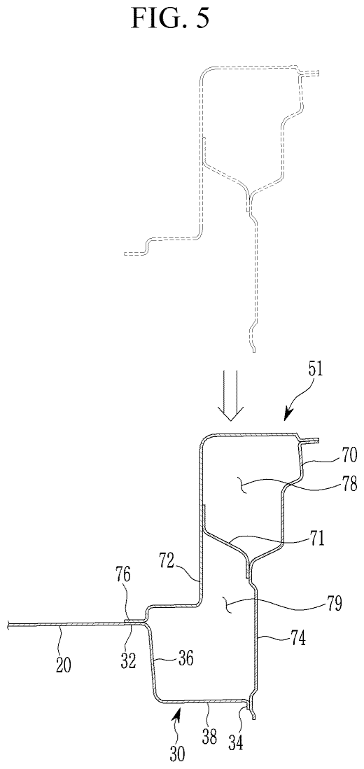

FIG. 5 shows an example of the rear structure of a vehicle body applied to a hailing vehicle according to an embodiment.

In explaining the configuration shown in FIG. 5, for the convenience of understanding, a repeated explanation of configurations similar or identical to those shown in FIG. 1 to FIG. 4 described above is omitted.

A back panel 51 illustrated in FIG. 5 may include a front body 72 connected to the upper junction part 32, a rear body 74 connected to the lower junction part 34, and a main body 70 formed by protruding upward from the front body 72 and the rear body 74.

A vehicle to which the back panel 51 illustrated in FIG. 5 is applied is a vehicle that requires a protruded configuration that supports a blocking wall or door protruding upward from the rear of the vehicle body, such as a van vehicle or a hailing vehicle transporting occupants.

The main body 70 may be applied to such a vehicle body to block the rear of the vehicle body or to support a rear door (not shown).

The back panel 51 may further include a front connection portion 76 formed in a horizontal direction parallel to the rear panel 20 and formed at the front of the front body 72 where the front body 72 and the rear panel 20 are connected.

As described above, the upper junction part 32 is formed in a horizontal direction parallel to the rear panel 20, and the lower junction part 34 may be bent in the lower direction of the vehicle body 10.

Therefore, as shown in the drawing, the back panel 51 applicable to the hailing vehicle may be connected to the lower member 30 in the vertical direction of the vehicle body 10.

The back panel 51 may form a back panel closed section 79 between the back panel 51 and the lower member 30.

The lower member 30 and the back panel 51 form the back panel closed section 79, which increases the width direction cross-section coefficient of the vehicle body 10 and may enhance the width direction strength of the vehicle body 10.

Additionally, the back panel closed section 79 may act as a buffer to absorb impact in the event of a rear collision of the vehicle.

The back panel 51 may further include a main body closed section 78 formed within the main body 70.

That is, the main body 70 may further include a main body connecting member 71 connecting the front body 72 and the rear body 74, and the main body connecting member 71 may form a main body closed section 78 inside the main body 70.

The main body connecting member 71 and the main body closed section 78 may increase the width direction cross-section coefficient of the vehicle body 10 and enhance the width direction strength of the vehicle body 10.

Additionally, the main body closed section 78 may act as a buffer to absorb impact in the event of a rear collision of the vehicle.

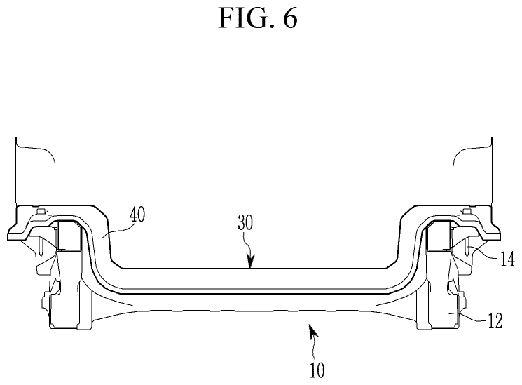

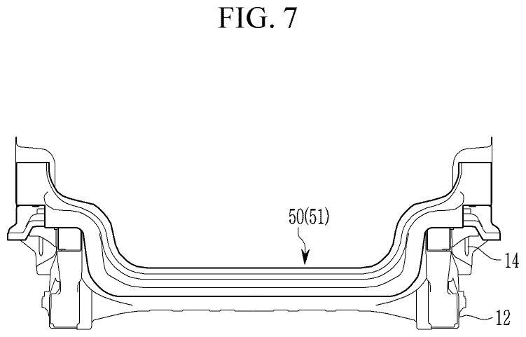

FIG. 6 and FIG. 7 are drawings showing an example in which the rear structure of a vehicle body according to an embodiment is applied to a chassis frame vehicle body.

Referring to FIG. 2, FIG. 6, and FIG. 7, the rear panel 20 may include a rear panel side portion 22 formed by bending upward in the width direction of the vehicle body 10, and the lower member 30 may include a lower member side portion 40 which is formed by bending upward in the width direction of the vehicle body 10 and is connected to the rear of the rear panel side portion 22.

The vehicle body 10 includes a chassis frame 12, and the lower member side portion 40 may be connected to the chassis frame 12.

That is, the vehicle body 10 illustrated in FIG. 6 and FIG. 7 is a chassis frame vehicle, to which the rear structure of a vehicle body according to an embodiment may be applied.

For example, the lower member side portion 40 and the chassis frame 12 may be joined by a mounting bolt 14.

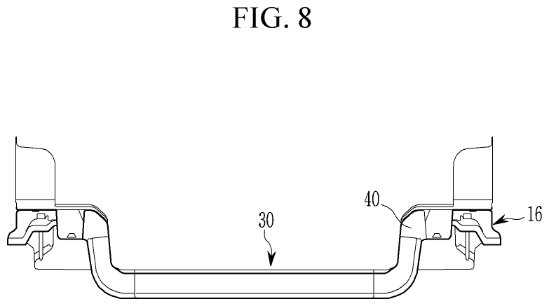

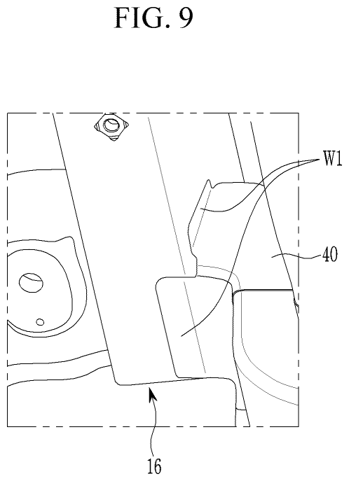

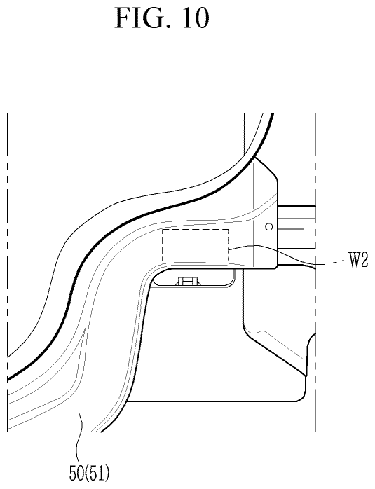

FIG. 8 is a drawing showing an example of the rear structure of a vehicle body applied to a monocoque vehicle body according to an embodiment, and FIG. 9 and FIG. 10 are drawings showing examples of a connection between the rear structure of a vehicle body and the monocoque vehicle body according to an embodiment.

The vehicle body 10 illustrated in FIG. 8 is a monocoque type vehicle. For the convenience of understanding, any repetition of the contents described in FIG. 6 and FIG. 7 will be omitted.

Referring to FIG. 2 and FIG. 8 to FIG. 10, the vehicle body 10 may include a side member 16, and the lower member 30 may include a lower member side portion 40 formed to be bent upward in the width direction of the vehicle body 10.

For example, as shown in FIG. 9, the lower member side portion 40 may be connected to the side member 16 by welding W1, and the back panels 50 and 51 may be connected to the side member 16 by welding W2 as shown in FIG. 10.

As described above, the rear structure of a vehicle body according to an embodiment may ensure production flexibility and be applied to various vehicle types.

That is, the rear structure of a vehicle body according to an embodiment may be applied to various types of vehicles, such as a hailing type vehicle transporting occupants, a delivery type vehicle having a luggage room, a van vehicle, etc.

Additionally, the rear structure of a vehicle body according to an embodiment may be applied to a chassis frame type vehicle or a monocoque type vehicle.

According to an embodiment of the rear structure of a vehicle body, the production cost may be reduced by increasing the common number of parts applicable to various vehicle types.

That is, according to an embodiment of the rear structure of a vehicle body, the lower member may be shared and applied to vehicles with various rear panel lengths or vehicles with different back panel configurations.

According to the rear structure of a vehicle body according to an embodiment, production efficiency may be improved by integrating production methods of various vehicle types.

That is, according to an embodiment of the rear structure of a vehicle body, the vehicle production efficiency may be improved by standardizing the method of connecting the back panel in the vertical direction of the vehicle body.

While embodiments of this invention have been described in connection with what is presently considered to be practical embodiments, it is to be understood that the embodiments of the invention are not limited to the disclosed embodiments. On the contrary, they are intended to cover various modifications and equivalent arrangements included within the spirit and scope of the appended claims.

What is claimed is:

1. A rear structure of a vehicle body, the rear structure comprising:
a rear panel positioned at a rear of the vehicle body; and
a lower member having an “L” shape cross-section, wherein the lower member comprises an upper junction part on an upper portion of the cross-section, and wherein the upper junction part is joined at a rear of the rear panel.

2. The rear structure of claim 1, wherein the upper junction part extends in a horizontal direction parallel to the rear panel.

3. The rear structure of claim 2, wherein the lower member further comprises a lower junction part at a lower portion of the cross-section.

4. The rear structure of claim 3, wherein the lower junction part extends in a vertical direction of the vehicle body.

5. The rear structure of claim 3, further comprising a back panel connected to the upper junction part and the lower junction part, wherein the back panel defines a back panel closed section therebetween with the lower member.

6. The rear structure of claim 5, wherein the back panel is connected to the lower member in a vertical direction of the vehicle body.

7. The rear structure of claim 6, wherein the back panel comprises:
an upper back panel connected to the upper junction part in a shape parallel to the rear panel; and
a lower back panel connected to the lower junction part.

8. The rear structure of claim 7, wherein the back panel further comprises a front connection portion extending in the horizontal direction parallel to the rear panel and disposed on a front of the upper back panel where the upper back panel and the rear panel are connected.

9. The rear structure of claim 6, wherein the back panel comprises:
a front body connected to the upper junction part;
a rear body connected to the lower junction part; and
a main body protruding upward from the front body and the rear body.

10. The rear structure of claim 9, wherein the back panel further comprises a front connection portion extending in the horizontal direction parallel to the rear panel and disposed on a front of the front body where the front body and the rear panel are connected.

11. The rear structure of claim 9, wherein the back panel further comprises a main body closed section defined within the main body.

12. The rear structure of claim 1, wherein:
the rear panel comprises a rear panel side portion comprising a first upward bend in a width direction of the vehicle body; and
the lower member comprises a lower member side portion comprising a second upward bend in the width direction of the vehicle body and connected to a rear of the rear panel side portion.

13. The rear structure of claim 12, wherein:
the vehicle body comprises a chassis frame; and
the lower member side portion is connected to the chassis frame.

14. The rear structure of claim 12, wherein:
the vehicle body comprises a side member; and
the lower member side portion is connected to the side member.

15. A vehicle comprising:
a vehicle body;
a rear panel disposed at a rear of the vehicle body; and
a rear complement mounted at a rear of the rear panel, the rear complement comprising:
a back panel; and
a lower member comprising:
an upper junction part connected to the rear of the rear panel;
a first body extending as a first bend from the upper junction part; and
a second body extending as a second bend from the first body, wherein the first body and the second body define an “L” shape cross-section.

16. The vehicle of claim 15, wherein the lower member further comprises a lower junction part extending as a third bend from the second body.

17. The vehicle of claim 16, wherein the upper junction part and the second body extending in a horizontal direction of the vehicle body, and wherein the first body and the lower junction part extend in a vertical direction of the vehicle body.

18. The vehicle of claim 16, wherein the back panel comprises:
an upper back panel connected to the upper junction part and extending parallel to the rear panel; and
a lower back panel connected to the lower junction part.

19. The vehicle of claim 18, wherein the back panel comprises:
a front body connected to the upper junction part;
a rear body connected to the lower junction part;
a main body protruding upward from the front body and the rear body; and
a front connection portion extending in a horizontal direction parallel to the rear panel and disposed on a front of the front body where the front body and the rear panel are connected.

20. The vehicle of claim 15, wherein:
the rear panel comprises a rear panel side portion comprising a first upward bend in a width direction of the vehicle body; and
the lower member comprises a lower member side portion comprising a second upward bend in the width direction of the vehicle body and connected to a rear of the rear panel side portion.
